(19) United States
(12) Patent Application Publication
(10) Pub. No.: US 2009/0031621 A1
(43) Pub. Date: Feb. 5, 2009

(54) All-Weather Farming House

(75) Inventor: Katsuyuki Kitagawa, Kaga-shi (JP)

Correspondence Address: OLIFF & BERRIDGE, PLC, P.O. BOX 320850, ALEXANDRIA, VA, 22320-4850, US

(73) Assignee: YUGENKAISHA JAPAN TSUSYO, KAGA-SHI (JP)

(21) Appl. No.: 11/989,708

(22) PCT Filed: Aug. 5, 2005
(86) PCT No.: PCT/JP2005/014419

§ 371 Date: Jan. 30, 2008

(51) Int. Cl. A01G 9/16; E04H 5/08

(52) U.S. Cl. 47/17; 52/79.1

(57) ABSTRACT

An all-weather farming house built by assembling segment pieces made of foamed polystyrene as a construction material. The farming house has formed inside a closed space for cultivating plants, and also has a lighting device and an air conditioning device.

### TECHNICAL FIELD

The present invention relates to an all-weather farming house for cultivating vegetables and fruits.

### BACKGROUND ART

Heretofore, there has been known a cultivation system for cultivating a vegetable and fruits indoors, such as in a polyvinyl house or in a cultivation factory (see, for example, Patent Document 1 below). Of these, in particular, the cultivation factory is resistant to disasters and enables cultivation of plants in a planned manner by artificially managing brightness, temperature and so on in the plant.

Patent Document 1: Japanese Laid-open Patent Application No. Hei-7-111828.

### DISCLOSURE OF THE INVENTION

### Problem to be Solved by the Invention

However, it requires much time and cost to construct a cultivation factory.

### SUMMARY OF THE INVENTION

The all-weather farming house according to the present invention is adapted to be assembled from a plurality of segment pieces made of foamed polystyrene as a construction material. The segment pieces are adapted to be assembled to form inside the assembled farming house a closed space for cultivating plants. The farming house also has a lighting device and an air conditioner.

The segment pieces may be formed in the form of a curved surface and assembled to form a substantially semi-cylindrical closed space.

It is preferred to join any two adjacent segment pieces end to end in a longitudinal direction through a reinforcing member.

The farming house may include a support block to be laid down on a site where the farming house is to be built. The fanning house may be adapted to be installed on the support blocks. In this case, the segment pieces are assembled by engaging lower ends thereof with the support blocks.

It is preferred to apply a reflection member that reflects illumination light from a lighting device on an inner surface of the closed space.

### ADVANTAGES OF THE INVENTION

According to the present invention, since the all-weather farming house is adapted to be assembled from the segment pieces made of foamed polystyrene as a construction material, a large-scale work operation on site as is experienced in building a cultivation factory is unnecessary, so that the construction schedule can be shortened and the cost can be lowered.

### BRIEF DESCRIPTION OF THE DRAWINGS

FIG. 1 is a perspective view showing an all-weather farming house in whole according to an embodiment of the present invention;

FIG. 2 is an exploded perspective view of FIG. 1;

FIG. 3 is an elevational view illustrating a state of assembly in the peripheral direction of the farming house;

FIG. 4 is an enlarged view of part IV of FIG. 3;

FIG. 5 is an enlarged view of part V of FIG. 3;

FIG. 6(a) is a perspective view illustrating a state of assembly in the anteroposterior direction of the farming house, FIG. 6(b) is a cross-sectional view along the VI-VI-line in FIG. 2, and FIG. 6(c) is a diagram showing a modification:

FIG. 7(a) is a cross-sectional view along a VII-VII line in FIG. 1 and FIG. 7(b) is an enlarged view of a major part thereof;

FIG. 8 is a cross-sectional view along a VIII-VIII line in FIG. 1;

FIG. 9 is a plan view showing an internal structure of the farming house according to the present invention; and

FIG. 10 is a plan view illustrating the flow of air in the farming house according to the present invention.

### EXPLANATION OF REFERENCE NUMERALS

11, 21 segment piece
30 support block
50 H-profiled steel bar
105 cultivation chamber
210, 211 lighting
220 air blower
230 air conditioning device

### BEST MODE FOR CARRYING OUT THE INVENTION

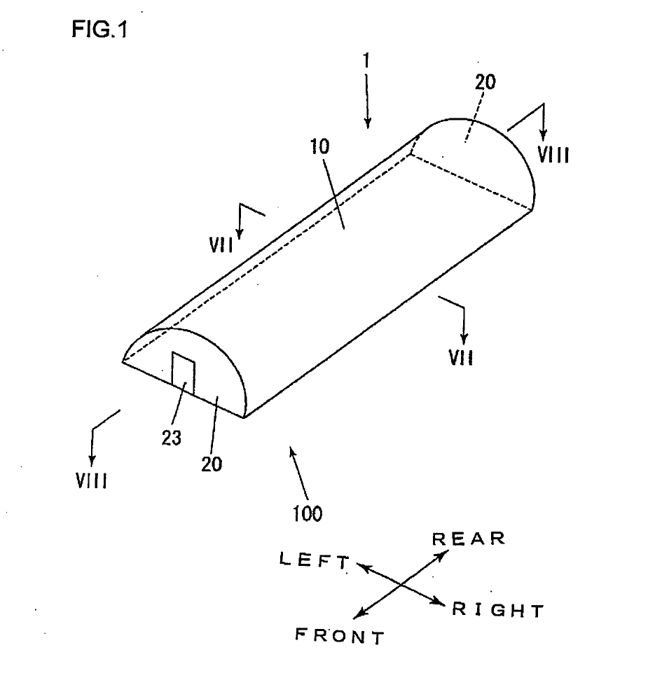

Hereinafter, the all-weather farming house according to an embodiment of the present invention is explained with reference to FIGS. 1 to 9.

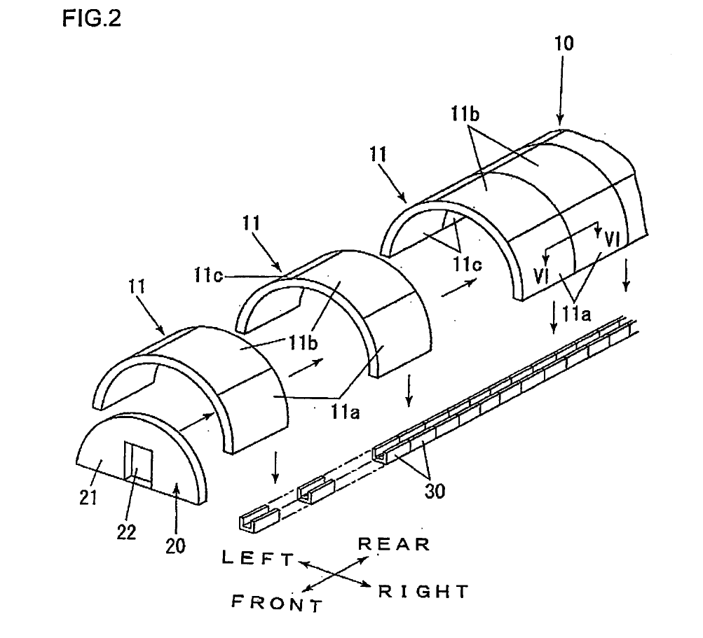

First, the shape of the all-weather farming house in whole is explained. FIG. 1 is a perspective view showing an appearance of the framing house 1 according to an embodiment of the present invention. FIG. 2 is an exploded perspective view of the farming house 1 shown in FIG. 1. Note that hereinafter, for convenience's sake, front, rear, left and right are defined as shown in the figures.

As shown in FIG. 1, the farming house 1 includes a semi-cylindrical peripheral wall 10 that is elongate in its anterioposterior direction and front and rear walls 20 that are substantially semi-diskoid and block the front and rear ends of the peripheral wall 1. The farming house 1 in whole is so-called tunnel-shaped.

As shown in FIG. 2, the peripheral wall 10 is assembled from a plurality of arcuate segment peripheral walls 11. Each segment peripheral wall 11 includes three segment pieces 11a to 11c. The segment peripheral walls contact each other at each end face thereof and are bonded to each other in the axial-longitudinal direction. The front and rear walls 20 include each a single segment piece 21. Note that the front and rear walls 20 may be obtained by collecting and assembling a plurality of segment pieces. Support blocks 30 detailed hereinbelow are arranged in two rows in the width direction of the farming house 1 and support the lower ends of the peripheral wall 10. The size of one framing house 1 is on the order of, for example, 5 to 10 m in width (length in the transverse direction), 20 to 50 m in depth (length in the longitudinal direction), and 3 to 5 m in height.

Each of the segment pieces 11a to 11c and 21 is a molded article made of foamed polystyrene having a blowing ratio of 10 to 50 folds and a thickness of 10 to 50 cm. For example, for land areas in which they have at most about 80 cm of deposited snow, segment pieces made of foamed polystyrene having a blowing ratio of 20 folds and a thickness of 20 cm may be used. Note that in order to obtain the same strength, a segment piece of foamed polystyrene having a greater blowing ratio must have a greater thickness. In land areas where it is unnecessary to take into consideration accumulation of snow, the foamed polystyrene may have a blowing ratio of 20 folds or more or a reduced thickness as small as 20 cm or less. On the contrary, in land areas in which they have deposited snow in a depth of 1 m or more, the foamed polystyrene must have a blowing ratio of more than 20 folds to secure its strength or an increased thickness. Foamed polystyrene of that kind has an excellent light blocking effect, so that light coming from outside can be cut.

The segment pieces 11a to 11c and 21 are produced in a factory in advance and assembled on site. The sizes of the segment pieces 11a to 11c and 21 are decided taking into consideration portability and assemblability thereof. Since the segment pieces 11a to 11c and 21 are made of foamed polystyrene, they are light in weight and easy to be transported and assembled. The segment piece 21 is formed in advance with an opening 22 that serves as a gateway for the farming house 1 and a door 23 (FIG. 1), which is openable and closable, is attached to the opening 22.

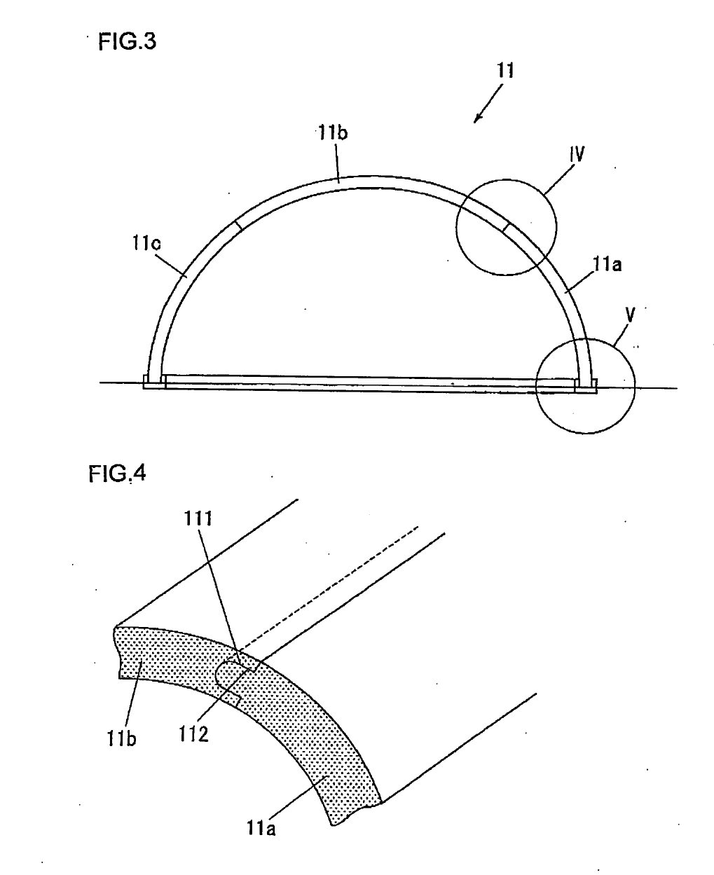

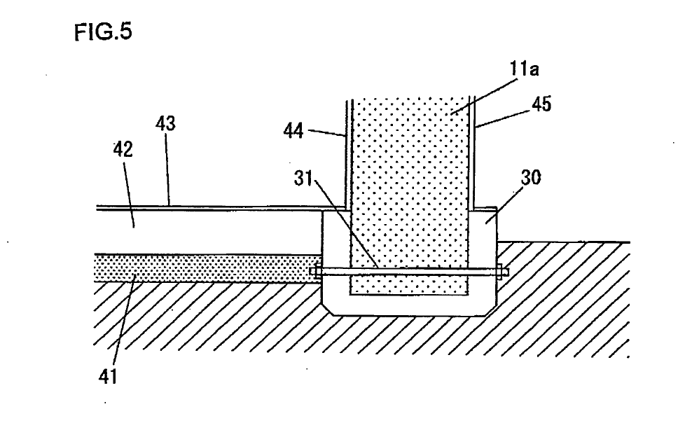

FIG. 3 is an elevational view illustrating a state of assembly of the segment peripheral wall 11 divided into three pieces. FIG. 4 is an enlarged view of the part IV of FIG. 3. FIG. 5 is an enlarged view of the part V of FIG. 5. As shown in FIG. 4, a protrusion 111 is formed on an upper end face of the segment piece 11a and a recess 112 is formed on a lower end face of the segment piece 11b facing the segment piece 11a. The protrusion 111 fits the recess 112 and in this state the segment pieces 11a and 11b are bonded and fixed to each other. Although not shown, the segment pieces 11b and 11c are bonded and fixed to each other similarly.

As shown in FIG. 2, a plurality of support blocks 30 is arranged on the ground in two rows at a distance that is equal to the width of the farming house 1. The support blocks 30 have each a substantially U-shaped cross-section as shown in FIG. 5 and the lower portion of each segment piece fits the U-shaped portion of the support block 30. The support block 30 is a secondary product of concrete. In FIG. 2, a portion of the support block 30 is laid underground to fix the support block 30 to the site. The lower end of the segment piece 11a is fastened to the support block 30 by a penetration bolt 31 that horizontally penetrates the support block 30. Though not shown, the lower end of the segment piece 11c is similarly fastened to the support block 30. This allows the farming house 1 to be built up on the site via the support block 30.

Between the left and right support blocks 30 is laid down a foamed matte 41, over which flooring concrete 42 is cast. A coating 43 is applied on the upper surface of the flooring concrete 42 to make the surface of the flooring in the house 1 have a flat surface having no unevenness. On an inner surface of each of the segment pieces 11a to 11c, there is applied a reflection member 44 that reflects light. The reflection member 44 may be, for example, an aluminum foil. Since the aluminum foil reflects not only light but also heat, the inside of the house 1 can be maintained in a uniform temperature environment. Note that instead of the aluminum foil, an aluminum plate may be applied. In this case, the aluminum plate can be applied easily because the house 1 is arcuate. Upon forming the segment pieces 11a to 11c, it would also be acceptable to first set the reflection member 44 such as an aluminum plate in a molding machine to integrally mold it together with the segment pieces 11a to 11c. In order to improve various properties of the house 1, such as fire resistance, fire retardance, weather resistance, water resistance, wound resistance, and sound insulation, there is coated on an outer surface of each of the segment pieces 11a to 11c a coating material 45 such as a resin concrete, which includes concrete and a polymer blended therein. Note that in order to increase bondability of the resin concrete, it is preferred that the house has a rough surface, and hence the surface of the segment pieces 11a to 11c is formed uneven.

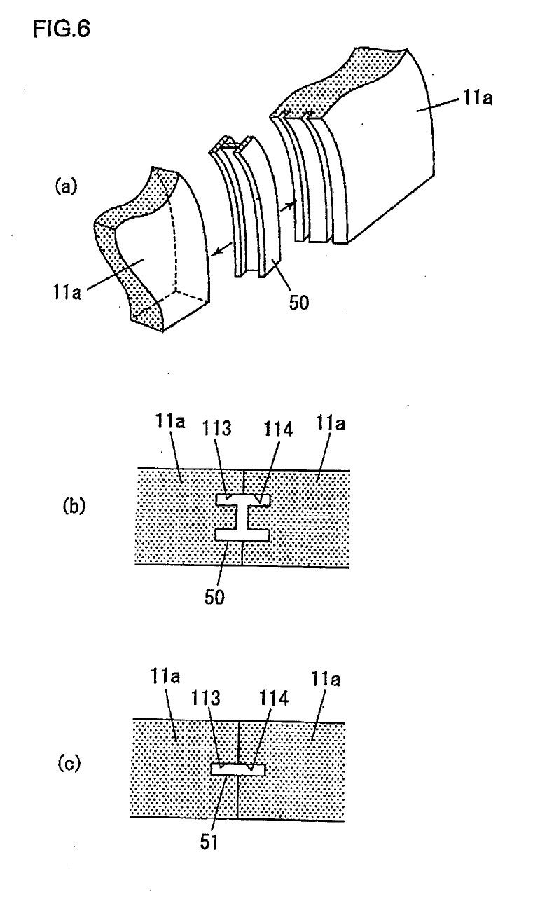

FIG. 6(a) is a perspective view illustrating a state in which the segment peripheral walls 11 are joined in the anteroposterior direction and FIG. 6(b) is a cross-sectional view of a joint section thereof (along the VI-VI-line in FIG. 2). Between any two adjacent segment pieces 11a, there is interposed a substantially semi-annular H-profiled steel bar 50 along the contour of the house. A lower end of the H-profiled steel bar 50 together with the segment piece 11a is integrally fastened to the support block 30 via the penetration bolt 31 (FIG. 5). Both the front and rear end faces of each segment piece 11a are each formed with recesses 113 and 114 for fitting the H-profiled steel bar 50 therein and the adjacent segment pieces 11a are bonded and fixed to each other through the H-profiled steel bar 50. Though not shown, the adjacent segment pieces 11b or the adjacent segment pieces 11c are joined to each other through the H-profiled steel bar 50 similarly. This allows the H-profiled steel bar 50 to function as a reinforcing member for the house 1 to increase the strength of the farming house in whole. As a result, it is possible from the viewpoint of strength to join the segment peripheral walls 11 to a length of several tens meters to assemble the house 1 or assemble the house 1 in a land area where they have much deposited snow.

When the strength of the house 1 need not be so high (for example, when there is no possibility of deposition of snow), a plate 51 instead of the H-profiled steel bar 50 may be interposed as shown in FIG. 6(c) to join the segment pieces 11 through the plate 51. Note that though not shown, a reinforcing member such as the H-profiled steel bar 50 or the plate 51 is also provided in the joint section between the segment peripheral wall 11 and the segment piece 21.

The farming house 1 made up of foamed polystyrene as a construction material is, unlike the polyvinyl house, resistant to damages and can fully endure disasters such as earthquakes and typhoons. In addition, even if cracks occurred on the surface of the house due to earthquake or partial deformation occurred on the surface of the house due to collision with a thing flown in a typhoon, their restoration can be easily performed. As compared with ordinary buildings or glass greenhouses, the farming house 1 of the present invention has less possibility of collapsing and is free from the care that broken glass will scatter in the house since no glass is used on the surface of the house. Further, the wall has a sufficient thickness, so that even if some shock is given thereto, the shock is prevented from reaching the inside of the house. Also, unlike the polyvinyl of the conventional polyvinyl house, there is no possibility that the foamed polystyrene of the farming house 1 is deformed or broken by wind to give damages to crops.

The foamed polystyrene has excellent thermal insulation properties and is light-shielding, so that use of it enables one to easily manage the cultivating environment of plants (vegetables and fruits) cultivated in the house, that is, temperature, humidity, light irradiation time and so on, and to get stable harvests without being influenced by external weather conditions. By realizing the present invention as a knock-down foamed house, the farming house 1 can be completed in a shorter time and at a lower cost than constructing a cultivation factory. Further, use of the reflection member 44 enables one to improve the efficiency of irradiation of light to a plant to be cultivated and reduce the number of installation sites of illumination light sources.

Explanation is made on an example of assembling procedure for assembling the all-weather farming house 1. First, as shown in FIG. 2, the support blocks 30 are laid down on a site where the house 1 is to be assembled. Then, a reinforcing member (for example, H-profiled steel bar 50) is set up at a position corresponding to the front of the house 1 and a front end of the recess 114 of each of the segment pieces 11a to 11c is fitted with the H-profiled steel bar 50. In this state, the lower end of the H-profiled steel bar 50 and the lower end of the segment pieces 11a or 11c are fastened to the support block 30 through the penetration bolts 31. On this occasion, any two adjacent segment pieces out of the segment pieces 11a to 11c are joined to each other in the peripheral direction through the recess 112 and the protrusion 111 and bonded to each other to form the segment peripheral wall 11. Then, the H-profiled steel bar 50 is fitted in the recess 113 at the rear end of the resulting segment peripheral wall 11. Until the house in whole reaches a predetermined length, the operation of joining the segment peripheral walls 11 to each other via the H-profiled steel bars 50 is repeated.

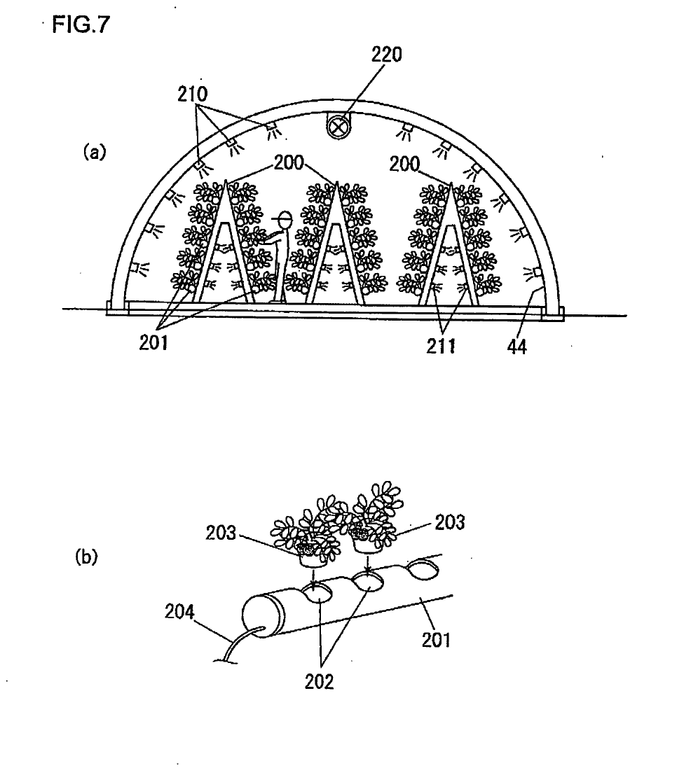

When the house in whole reaches the predetermined length, the foamed matte 41 is laid down between the left and right support blocks 30. Thereafter, the flooring concrete 42 is laid down thereover and the coating 43 is applied to the upper surface of the flooring concrete 42. Further, the reflection member 44 is applied to the inner surface of the house 1 and the coating material 45 is applied to the outer surface of the house 1. Then, large components or manufactured goods, such as cultivation racks 200 (FIG. 7), are brought in by using a heavy machine and the segment piece 21 is joined with the segment peripheral wall 11 at each of the front and rear end faces of the house 1 through the H-profiled steel bar 50. This closes the front and rear end faces of the house 1 to form a closed space shielded from the outside. Note that application of the reflection member 44 to the segment pieces 11a to 11c and application of the coating material 45 over the reflection member 44 in advance in a factory makes operations of assembling simpler.

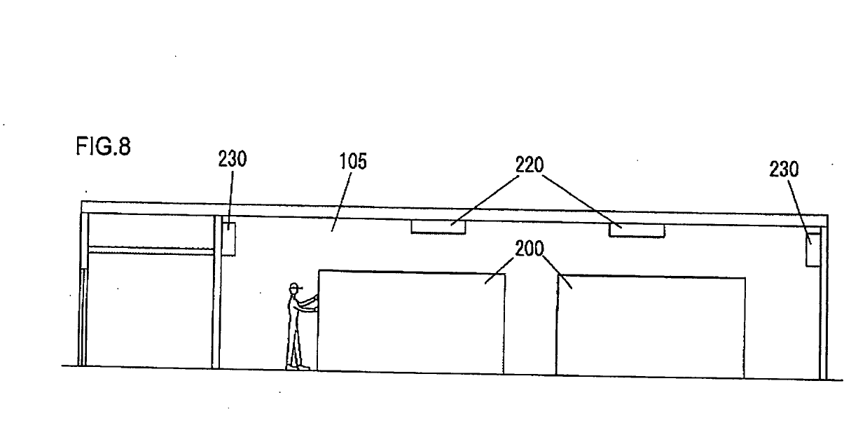

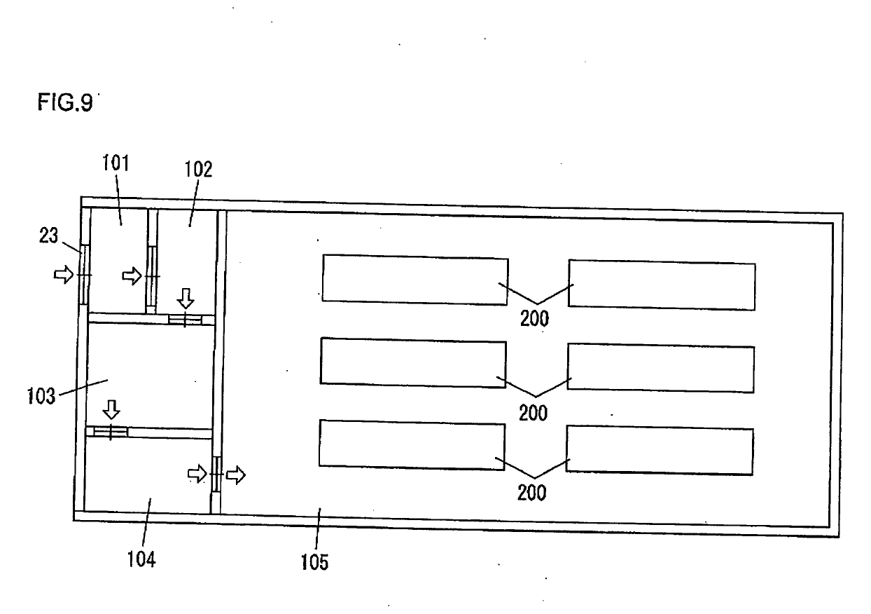

Then, explanation is made on an example of the internal structure of the farming house 1 when strawberry is cultivated therein. FIG. 7 is a cross-sectional view along the VII-VII line in FIG. 1. FIG. 8 is a cross-sectional view along the VIII-VIII line in FIG. 1. FIG. 9 is a plan view. These figures illustrate the internal structure of the framing house 1. As shown in FIG. 9, the inside of the house is sectioned into a wind shelter chamber 101, an air shower chamber 102, a changing/preparation chamber 103, a sterilization chamber 104, and a cultivation chamber 105.

In the cultivation chamber 105, there is set up a plurality of cultivation racks 200. For example, two sets in the width direction and two sets in the anteroposterior direction, thus six sets in total of the racks 200 are set up. As shown in FIG. 7(a), each cultivation rack 200 is substantially A-shaped as seen head-on and is provided on slanting outer sides thereof with cylindrical gutters 201 extending in the anteroposterior direction. The gutters 201 are provided in a plurality of stages (five stages in FIG. 7(a)) one above another, that is, the cultivation racks 200 constitutes a multi-stage cultivation rack.

As shown in FIG. 7(b), in each reception section 202 on the upper surface of the gutter 201, there is provided a pot 203, in which strawberry is cultivated. To each of the front and rear end faces of the gutter 201, there is connected a pipe 204 and a liquid fertilizer is supplied into the gutter 201 through the pipes 204 by driving a pump (not shown). The supplied liquid fertilizer flows along the bottom surface in the gutter 201 and then returned back to a tank. The liquid fertilizer is again supplied into the gutter 201 through the pipes 204. This allows the liquid fertilizer to circulate within the gutter 201 to supply strawberry with water and nutrients necessary for the cultivation of the strawberry through the pot 203. Since water and nutrients are supplied through the pipes 204 and the gutter 201 in this manner, there is no need to sprinkle water in the chamber. Accordingly, it is unnecessary to provide water discharge pits and water discharge ports, so that invasion and propagation of microorganisms can be prevented.

On the inner wall surface of the house, there is attached a plurality of illumination lamps 210 (for example, fluorescent lamps) for irradiating light on strawberry. Also, on the inner side of each cultivation rack 200, there are attached illumination lamps 211. Further, as mentioned above, the reflection member 44 is applied all over the inner surface of the house 1. This allows illumination light from every direction to be irradiated on the strawberry on the cultivation rack 200, so that uniform, high-quality strawberry fruits can be cultivated. In this case, the cultivation of strawberries can be accelerated by appropriately adjusting luminance and irradiation time of illumination light.

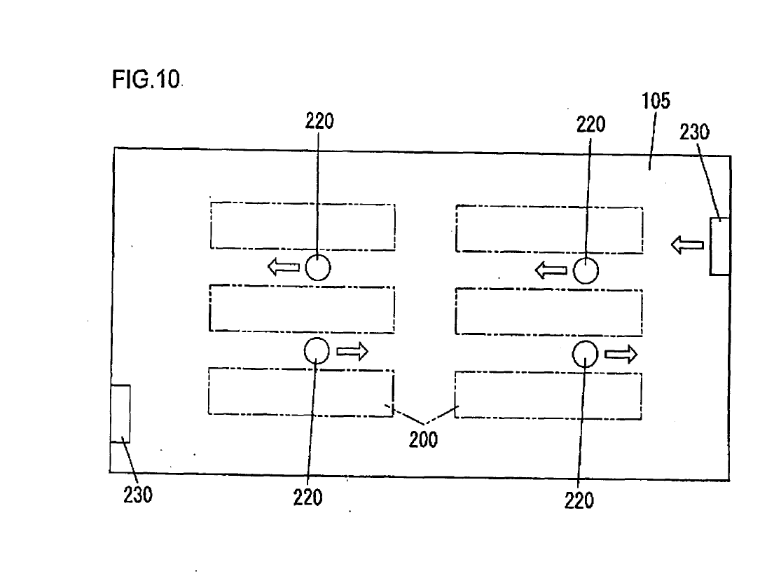

As shown in FIG. 7(a) and FIG. 8, there is attached on the ceiling section of the cultivation chamber 105 an air blower 220 and the flow of air is controlled such that outdoor air will not be directly sucked into the cultivation chamber. This prevents invasion of microorganisms and insects. Further, in the cultivation chamber 105, there is attached an air conditioning device 230 (air conditioner) and the inside of the chamber is air-conditioned to temperature and humidity suitable for cultivating strawberry. FIG. 10 is a plan view schematically illustrating the flow of air in the cultivation chamber 105. In FIG. 10, air circulates in the cultivation chamber 105 as indicated by the arrows to keep the atmosphere in the cultivation chamber 105 at a uniform air condition. In this case, since the ceiling section of the cultivation chamber 105 is shaped in an arcuate form, there occurs less air stagnation, so that the inside of the chamber can be easily set to a uniformly air conditioned state. Further, since the foamed polystyrene has excellent heat insulation properties, the farming house 1 can be air-conditioned more easily than a cultivation plant made of concrete. That is, use of the foamed polystyrene provides a farming house having high cooling and heating efficiency.

The order of entering or leaving the respective chambers 101 to 105 in the house is as indicated by the arrows in FIG. 9. That is, a worker first enters the wind shelter chamber 101 and then the air shower chamber 102 where the worker has dust or the like attached to the whole body removed by air shower. Then, the worker enters the changing/preparation chamber 103 where the worker takes the clothes for a work outfit to sake a preparation. When entering the sterilization chamber 104, the worker has the whole body sterilized and thereafter enters the cultivation chamber 105. This procedure prevents invasion of microorganisms and insects from outside when the worker enters the cultivation chamber 105, so that acceptable hygienic conditions can be maintained.

Further, the inner surface of the farming house 1 from the bottom to the top in whole is in the form of a curved surface and has less uneven portions thereon, so that dust and microorganisms hardly accumulate in the house to provide an extremely hygienic space in the chamber. The illumination lamps 210 may be embedded in the inner surface of the segment pieces 11a to 11c. This makes it possible to avoid unevenness on the surface of the attachment sections of the illumination lamps 210, which is preferred from the hygienic point of view.

According to the above-mentioned embodiment, the following advantages are obtained.

(1) Since the farming house 1 is adapted to be assembled from the segment pieces 11a to 11c and 21 made of foamed polystyrene as a construction material, the farming house 1 in whole can be covered with foamed polystyrene of a considerable thickness, so that a sufficient strength of the farming house 1 can be secured. Further, a large-scale work operation on site as is experienced in building a cultivation factory is unnecessary, so that the construction schedule can be shortened and the cost can be lowered. That is, since the farming house 1 stands up by itself by assembling the segment pieces 11a to 11c and 21, it is only necessary to assemble on site the segment pieces 11a to 11c and 21 that have been produced in advance in a factory, so that the operation on site is easy. Upon assembling, no special technology is required, so that laymen can easily assemble them.

(2) Since the foamed polystyrene is used as a construction material, the farming house 1 has excellent heat insulation properties and light shielding properties and the inside of the house can be efficiently set to an environment that is suitable for cultivated plants. Further, since the foamed polystyrene is light in weight, it can be easily transported and assembled. Also, it can be easily recycled.

(3) Since the farming house 1 is adapted to be formed by adding segment peripheral walls 11 to obtain the farming house that is elongate, the farming house 1 can be easily varied to the house 1 having any desired size that conforms to the configuration of the earth's surface.

(4) Since the adjacent segment peripheral walls 11 are jointed to each other through the H-profiled steel bars 50, the H-profiled steel bars serve as reinforcing members to provide the house itself with a sufficient strength. Therefore, the farming house 1 can be used in areas where they have much deposited snow.

(5) Since the segment peripheral walls 11 are bonded to each other via recesses 113 and 114 formed on the both end faces of each segment peripheral wall and the H-profiled steel bar 50 fitted therein, the H-profiled steel bar is not exposed, so that the house 1 can be covered with the foamed polystyrene all over the surface thereof.

(6) Since the house 1 is adapted to be supported through the support blocks laid down on the site, foundation construction as is needed by ordinary buildings is unnecessary, so that the house 1 can be completed in a relatively short period of time. Further, since the segment piece 11a or 11c and the H-profiled steel bar 50 are fastened integrally to the support block 30 through the bolt 31, the number of fastening spots for the bolt 31 is made relatively small, so that the work operation is relatively easy. Movement and withdrawal operations of the house 1 are also relatively easy.

(6) Since the farming house 1 is adapted to be formed in the form of a curved surface (arcuate) from the bottom to the ceiling section thereof, the inner surface of the house 1 has less unevenness, so that accumulation of dust and microorganisms in the house can be suppressed. Also, the inside of the house can be easily set to a uniformly air-conditioned state.

(7) Since the reflection member 44 is applied to the inner surface of the house 1, illumination light reflects on the reflection member 44, so that cultivation on the multi-stage cultivation racks 200 can be performed without provision of a number of illumination lamps 210.

Note that in the above-mentioned embodiment, the farming house 1 is adapted to be formed in an arcuate form to provide a closed space of a substantially semi-cylindrical form (approximately tunnel-shaped) therein. However, since the farming house 1 is adapted to be assembled from a plurality of segment pieces, the shape of the framing house 1 is not limited to the above-mentioned one and the shape of segment pieces is not limited to the above-mentioned one. For example, the house in whole may be of a semi-spherical or rectangular parallelepiped form. A roof formed by assembling the segment pieces may be placed on a side wall formed by assembling the segment pieces.

In the above-mentioned embodiment, explanation has been made on the example in which strawberry is cultivated in the farming house 1. However, other fruits, vegetables, mushrooms and so on may be cultivated in the farming house 1. When mushrooms are cultivated, it is preferred to control illumination and air condition such that it is relatively dark and at a high humidity in the house. In addition to foods, plants such as flowers may be cultivated.

In the above-mentioned embodiment, the H-profiled steel bar 50 or the plate 51 is inserted as a reinforcing member in the joint section between adjacent segment pieces in the anteroposterior direction thereof. However, the shape of the reinforcing member is not limited thereto. The reinforcing member may be omitted. The reinforcing member may be provided in the joint section between the segment pieces not only in the anteroposterior direction thereof but also in the peripheral direction thereof. Also, in the above-mentioned embodiment, the cultivation is performed by setting the multi-stage racks 200 in the house. However, the construction of the inside of the house is not limited to the above-mentioned ones. Since the house 1 is wide and high, it is possible to bring a cultivator or tiller to perform tillage cultivation therein.

Although the farming house 1 is configured to be supported through the support blocks 30 having a substantially U-shaped cross-section, the shape of the support block is not limited thereto. For example, the segment pieces 11a and 11c may be provided with a recess or a protrusion on the bottom thereof and the support block may be configured to be fitted with the recess or the protrusion. The site for installing the farming house 1 is not limited to the ground. The farming house 1 may be installed, for example, on a roof. It would be also acceptable to install a plurality of farming houses 1 and cultivate different plants in different farming houses. Alternatively, it would be acceptable to provide a plurality of cultivation chambers 105 in a single farming house and cultivate different plants in different cultivation chambers.

That is, as far as the features and functions of the present invention are realized, the present invention is not limited to the all-weather farming house according to the above-mentioned embodiment. Note that the above-mentioned explanations are only exemplary and when interpretation of the present invention is made, there should be no limits and bounds in correspondence relationship between what is described in the above-mentioned embodiment and what is described in the appended claims.

1. An all-weather farming house comprising:
a plurality of segment pieces made of foamed polystyrene as a construction material, adapted to be assembled so as to form a closed space allowing cultivation of a plant therein; and
a lighting device and an air conditioning device, wherein the farming house is provided with a doorway section that allows a worker to enter/leave the closed space.

2. An all-weather farming house according to claim 1, wherein:
the segment pieces are each in the form of a curved surface, and
the closed space is in the form of a substantially semi-cylindrical form.

3. An all-weather farming house according to claim 1, wherein:
any two adjacent segment pieces out of the segment pieces are joined end to end in a longitudinal direction through a reinforcing member.

4. An all-weather farming house according to claim 1, further comprising:
support blocks to be laid down on a site where the all-weather farming house is to be installed, wherein:
the all-weather farming house is adapted to be installed on the support blocks, with lower ends of the segment pieces being adapted to be fitted with the support blocks.

5. An all-weather farming house according to claim 1, further comprising:
a reflection member applied to an inner surface of the closed space reflecting illumination light from the lighting device.

6. An all-weather farming house according to claim 5, wherein:
the reflection member is an aluminum foil or an aluminum plate.

7. An all-weather farming house according to claim 4, further comprising:
fastening members that fasten lower ends of the plurality of segment pieces to the support blocks.

8. An all-weather farming house according to claim 1, wherein:
among the plurality of segment pieces, end faces of any two adjacent segment pieces are bonded and assembled to each other.

9. An all-weather farming house according to claim 1, wherein:
the plurality of segment pieces have coated on outer surfaces thereof a weather resistant material.

10. An all-weather farming house according to claim 1, further comprising:
at least one cultivation rack for cultivating a farm product in the closed space.

11. An all-weather farming house according to claim 10, further comprising:
the lighting device is attached to an inner side of the at least one cultivation rack.

12. An all-weather farming house according to claim 1, further comprising:
a plurality of spaces isolated from the closed space, wherein
at least one space out of the plurality of spaces isolated from the closed space is provided between the doorway section and the closed space.
